(19) United States
(12) Patent Application Publication
(10) Pub. No.: US 2023/0399215 A1
(43) Pub. Date: Dec. 14, 2023

(54) LIFT WITH SWIVELING AND HORIZONTALLY SLIDING PLATFORM

(71) Applicant: Microsoft Technology Licensing, LLC, Redmond, WA (US)

(72) Inventors: Jose Seah DELAPAZ, Mill Creek, WA (US); Richard Donald HAGE, Duvall, WA (US); Jeremy Alan YOUNG, Sammamish, WA (US); Marc Steven BOWSER, Overland Park, KS (US); Mark Joseph BARACANI, Golden, CO (US)

(21) Appl. No.: 17/840,359

(22) Filed: Jun. 14, 2022

(51) Int. Cl. B66F 17/00; B66F 11/04

(52) U.S. Cl. CPC B66F 17/006; B66F 11/042

(57) ABSTRACT

The disclosed technology is generally directed to a lift. In one example of the technology, a lift comprises a chassis, a mounting base, a platform, a motor, a plurality of guardrails, and a counterweight. The mounting base is arranged to swivel relative to the chassis. The platform is coupled to the mounting base. The platform is arranged to slide horizontally relative to the mounting base. The motor is arranged to raise and lower the mounting base relative to the chassis. The plurality of guardrails is coupled to the platform. The counterweight is coupled to the chassis such that the counterweight prevents the lift from tipping over while the platform is extended relative to the mounting base.

### BACKGROUND

An aerial work platform (AWP) is a device that may typically be used to provide temporary access for people or equipment to inaccessible areas, usually at height. Aerial work platforms are generally used for temporary, flexible-access purposes such as maintenance and construction work or by firefighters for emergency access. An aerial work platform that is capable of vertical movement may also be referred to as a lift. There are distinct types of lifts, and the individual types may also be known as, for example, a “boom lift” or a “scissor lift.”

A scissor lift is a type of lift with a work platform that moves vertically through the use of linked, folding supports in a crisscross X pattern, known as a pantograph, scissor mechanism, or scissor linkage. The upward motion may be achieved by the application of pressure to the outside of the lowest set of supports, elongating the crossing pattern, and propelling the work platform vertically. The contraction of the scissor action is typically hydraulic, pneumatic, or mechanical (via a leadscrew or rack-and-pinion system). Scissor lifts are often operated by lift operators, who are supported in a passenger basket of the scissor lift, to allow the operators to accomplish a task, manage a repair, or perform inspections on an elevated structure.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to a lift. In some examples, a lift comprises a chassis, a mounting base, a platform, a motor, a plurality of guardrails, and a counterweight. In some examples, the mounting base is arranged to swivel relative to the chassis. In some examples, the platform is coupled to the mounting base. In some examples, the platform is arranged to slide horizontally relative to the mounting base. In some examples, the motor is arranged to raise and lower the mounting base relative to the chassis. In some examples, the plurality of guardrails is coupled to the platform. In some examples, the counterweight is coupled to the chassis such that the counterweight prevents the lift from tipping over while the platform is extended relative to the mounting base.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a functional block diagram illustrating an example of a lift;

FIG. 2 is a diagram illustrating a perspective view of an example of a scissor lift that may be employed as an example of the lift of FIG. 1;

FIG. 3 is a diagram illustrating perspective views of an example of a raising action of the scissor lift of FIG. 2;

FIG. 4 is a diagram illustrating perspective views of an example of a horizontally sliding action of the scissor lift of FIG. 2;

FIG. 5 is a diagram illustrating perspective views of an example of a swiveling action of the scissor lift of FIG. 2; and

FIG. 6 is a flow diagram illustrating an example process for a lift, in accordance with aspects of the disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof.

Briefly stated, the disclosed technology is generally directed to a lift. In some examples, a lift comprises a chassis, a mounting base, a platform, a motor, a plurality of guardrails, and a counterweight. In some examples, the mounting base is arranged to swivel relative to the chassis. In some examples, the platform is coupled to the mounting base. In some examples, the platform is arranged to slide horizontally relative to the mounting base. In some examples, the motor is arranged to raise and lower the mounting base relative to the chassis. In some examples, the plurality of guardrails is coupled to the platform. In some examples, the counterweight is coupled to the chassis such that the counterweight prevents the lift from tipping over while the platform is extended relative to the mounting base.

In some examples, a lift, such as a scissor lift, or other suitable lift, has a platform that is capable of swiveling. The lift may incorporate various features, including various safety features that may help protect people and property.

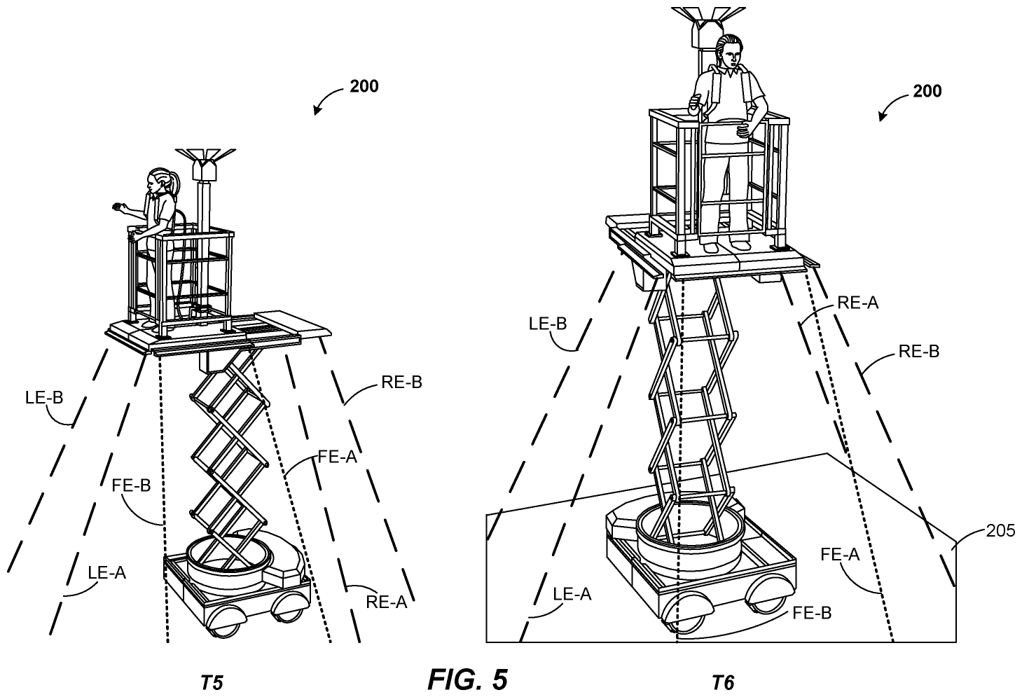

With regard to the lift, “down” may refer to the direction towards the ground/floor, and “up” may refer to the direction that is directly opposite “down.” Similarly, when referring to the lift or to a component of the lift, the term “bottom” may refer to the side/portion of the component that is closest to the ground/floor, and “top” may refer to the side/portion of the component that is farthest from the ground/floor. FIG. 5 shows an example of the floor 205 at time T6.

In some examples, the lift has a chassis at the bottom of the lift. In some examples, coupled to the bottom of the chassis are wheels, a track system, or the like, so that the lift is mobile. In some examples, the lift has a mounting base that may be raised and lowered in elevation relative to the chassis. For example, the lift may be a scissor lift with a scissor linkage that is coupled to the chassis and is coupled to the mounting base. More specifically, in some examples, the scissor linkage is coupled to the chassis and is coupled to the mounting base in the following manner: the bottom of the scissor linkage is coupled to the top of the chassis, and the top of the scissor linkage is coupled to the bottom of the mounting base. In some examples, the scissor linkage can raise and lower the elevation of the mounting base relative to the chassis.

In some examples, a platform is positioned on top of the mounting base and movably affixed to the mounting base. More specifically, in some examples, the platform is positioned on top of the mounting base and movably affixed to the mounting base. For instance, in some examples, the platform is attached to the mounting base, and the platform can also move relative to the mounting base, as discussed further herein. In some examples, the mounting base includes grooved tracks at the top of the mounting base. Further, in some examples, the bottom of the platform includes wheels that fit within the grooved tracks at the top of the mounting base. In some examples, the platform is a surface on which an operator can stand in to do work. The platform may have guardrails coupled to the platform, forming a basket in which the operator can perform work and with the guardrails helping to prevent the operator from falling.

In some examples, the platform, along with the guardrails, is capable of swiveling relative to the chassis. For example, the lift may include a rotating base that is coupled to the top of the chassis and to the bottom of the scissor linkage. In this way, in some examples, when the rotating base rotates relative to the chassis, the mounting base rotates relative to the chassis, and the platform, along with the guardrails, rotates relative to the chassis along with the mounting base. The swiveling motion may make it easier for the operator to reach certain areas, and to do so in a safer manner.

The platform, along with the guardrails, may slide horizontally relative to the mounting base. The horizonal sliding of the platform may be used to bring an operator in closer proximity to a maintenance or repair item.

The combination of the swiveling motion of the platform and the horizontal sliding of the platform may make it significantly easier and safer for the operator to perform certain functions, while reducing stress and strain on the operator and not requiring the operator to reach and lean over the rail to attempt a task. For instance, when a scissor lift is typically used in a data center, there may be a number of items, such as bus plugs, over the top of racks that require reaching. The horizonal sliding of the platform may be used to allow the operator access to such items without reaching. The horizontal sliding of the platform may accordingly reduce the risk of falling, and reduce stress on the operator's body from reaching and straining.

Additionally, in some examples, the basket can be swiveled in a desired direction, and then the basket can be extended in a desired direction, which need not be the same direction as the direction of driving of the lift. For instance, typically, when an operator is using a scissor lift to perform work in a data center with server racks, the operator proceeds as follows. Typically, when the operator is working above a rack, the operator needs to do the work and then back up the scissor lift. Next, typically, the operator will then turn the scissor lift 90 degrees and then drive the scissor lift up to the next rack. Next, typically, the operator will then turn the scissor lift 90 degrees towards the rack, then drive the scissor lift up to the next rack, and so on. However, according to some examples, the scissor lift may instead be used to swivel the basket 90 degrees and then extend the basket towards the rack. The operator may then simply drive the scissor lift down the rack to perform work in each new area, with no backing up or turning needed.

The lift may also have an adjustable lighted Controlled Access Zone (CAZ). In some examples, the lights define a CAZ zone for which personnel not equipped with fall arrest equipment or fall restraint equipment are not permitted to enter. For instance, in some examples, the mounting base has a laser light or light-emitting diode (LED) light disposed on each side of the bottom of the mounting base and/or the platform. In some examples, the CAZ zone has dimensions that are adjustable. For instance, in some examples, the higher the platform, the greater the size of the CAZ zone. In some examples, when the platform swivels or slide horizontally, the dimensions of the CAZ zone change accordingly. The precise manner in which the dimensions of the CAZ zone are adjusted according to various examples is discussed in greater detail below.

Various examples of the lift may also have various other features, including various other safety features, which are discussed in greater detail below.

### Illustrative Device

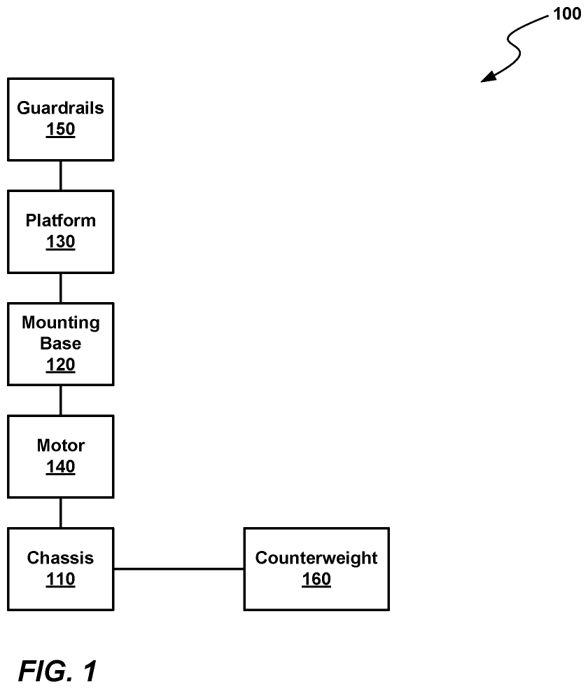

FIG. 1 is a is a functional block diagram illustrating an example of lift 100. Lift 100 may include chassis 110, mounting base 120, platform 130, motor 140, guardrails 150, and counterweight 160. In various examples, lift 100 may be a scissor lift, a hydraulic lift, or other suitable type of lift.

In some examples, chassis 110 is at the bottom of lift 100, and there may be wheels, a track system, or the like coupled to the bottom of chassis 110 so that lift 100 is mobile. In some examples, lift 100 is designed to elevate an operator to do work at a height. The operator may stand on platform 130. In some examples, guardrails 150 are coupled to platform 130, so that platform 130 and guardrails 150 form a basket in which the operator may stand to perform work. Guardrails 150 may help to prevent the operator from falling.

In some examples, platform 130 is positioned on top of mounting base 120 and movably affixed to mounting base 120. More specifically, in some examples, platform 130 is positioned on top of mounting base 120 and movably affixed to mounting base 120 as follows. In some examples, mounting base 120 includes grooved tracks at the top of the mounting base 120. Further, in some examples, the bottom of platform 130 includes wheels that fit within the grooved tracks at the top of mounting base 120. Motor 140 may be arranged to raise and lower the elevation of mounting base 120 relative to chassis 110. In some examples, when mounting base 120 is raised or lowered, platform 130 is likewise raised or lowered.

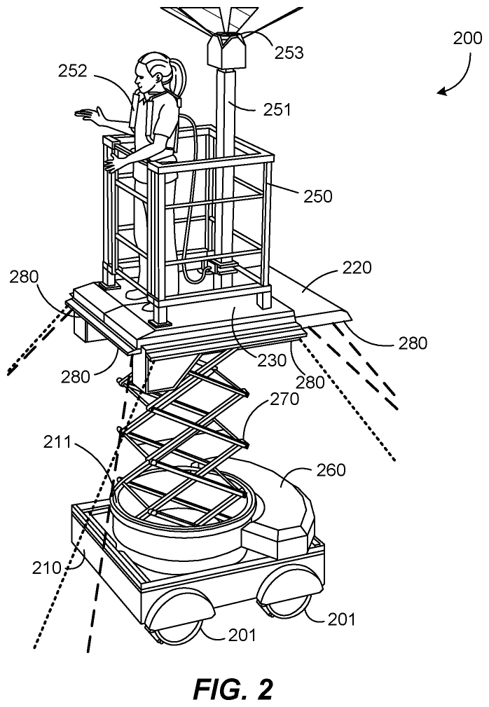

The raising and lowering of mounting base 120 may be accomplished in different ways in different examples of lift 100. For instance, in some examples, lift 100 is a scissor lift. Various examples of a scissor lift are discussed in greater detail below with regard to FIG. 2. In some examples, platform 130, along with guardrails 150, is capable of swiveling relative to chassis 110. Some examples of the swiveling are discussed in greater detail below with regard to FIG. 2. Briefly though, in some examples, rotation of a rotating base relative to chassis 110 causes mounting base 120 to rotate relative to chassis 110, and platform 130, along with guardrails 150, rotate relative to chassis 110. In some examples, mounting base 120 is capable of rotating at any angle (i.e., a full 360 degrees) relative to chassis 110.

In some examples, platform 130, along with guardrails 150, may slide horizontally relative to mounting base 120. In some examples, platform 130 is capable of both swiveling relative to chassis 110 and horizontally sliding relative to mounting base 120. In this way, in some examples, platform 130 may extend in a direction that is different than the direction of driving lift 100, such as 90 degrees from the direction of driving.

In some examples, counterweight 160 is on the opposite side of lift 100 as the direction in which platform 130 extends relative to mounting base 120. In some examples, counterweight 160 rotates along with mounting base 120, so that when mounting base 120 rotates, counterweight 160 also rotates. In this way, in some examples, counterweight 160 remains on the opposite side as of lift 100 from the direction in which platform 130 extends horizontally relative to mounting base 120. In some examples, this positioning of counterweight 160, along with the weight of counterweight 160, prevents lift 100 from tipping over when platform 130 is both fully extended relative to mounting base 120 and fully raised relative to chassis 110. In some examples, counterweight 160 extends outwards as platform 130 raises and/or extends in order to further counterbalance platform 130. In some examples, lift 100 further includes proximity sensors to determine whether counterweight 160 may hit an obstruction if counterweight 160 extends, and lift 100 may cease operation if the proximity sensors detect that counterweight 160 may hit an obstruction if counterweight 160 extends.

FIG. 2 is a diagram illustrating a perspective view of an example of scissor lift 200. Scissor lift 200 may be employed as an example of lift 100 of FIG. 1. Scissor lift 200 may include chassis 210, mounting base 220, platform 230, guardrails 250, counterweight 260, scissor linkage 270, lights 280, wheels 201, rotating scissor linkage base 211, mast 251, safety harness 252, and proximity sensors 253. Scissor lift 200 may have various internal components not shown in FIG. 2, including, for example, a motor.

As shown in FIG. 2, in some examples, scissor lift 200 includes a chassis 210 with wheels 201 coupled to the bottom of chassis 210. Wheels 201 may allow the entire scissor lift 200 to be moved/driven by means of one or more motors in scissor lift 200. In some examples, scissor lift 200 may include a track system instead of wheels 201. In some examples, the track system may be a non-marking rubberized track system. As shown in FIG. 2, in some examples, scissor lift 200 further includes a counterweight 260 that is coupled to chassis 210.

As shown in FIG. 2, scissor lift 200 may include a rotating scissor linkage base 211 that is coupled to the top of chassis 210. As further shown in FIG. 2, scissor lift 200 may include a scissor linkage 270 that is coupled to rotating scissor linkage base 211 and is coupled to mounting base 220. More specifically, in some examples, scissor linkage 270 is coupled to rotating scissor linkage base 211 and is coupled to mounting base 220 in the following manner: the bottom of scissor linkage 270 is attached to rotating scissor linkage base 211, and the top of scissor linkage 270 is attached to the bottom of mounting base 220. Scissor linkage 270 may include linked, folding supports that are arranged in a crisscross X pattern. In some examples, scissor linkage 270 can cause the elevation of mounting base 220 to raise and lower relative to chassis 210. In some examples, scissor linkage 270 may raise mounting base 220 through pressure applied to the outside of the lowest set of supports on scissor linkage 270, which then elongates the crossing pattern on scissor linkage 270. In various examples, the contraction of the scissor action may be, for example, hydraulic, mechanical, pneumatic, and/or in another suitable manner.

As further shown in the example illustrated in FIG. 2, scissor lift 200 further includes a platform 230 that is coupled to the top of mounting base 220. As further shown in FIG. 2, scissor lift 200 may have guardrails 250 coupled to platform 230 such that platform 230 and guardrails 250 form a basket. In some examples, platform 230 acts as a surface for an operator to stand on, inside of the basket, while doing work in an elevated position. In some examples, guardrails 250 are arranged in other suitable ways and do not form a basket. In some examples, as shown in FIG. 2, scissor lift 200 includes a safety harness 252 that an operator may wear to help prevent falling from scissor lift 200.

Although not shown in FIG. 2, in some examples, scissor lift 200 further includes clamps that are placed in such a way that a wheelchair may be locked onto platform 230 to allow an operator with limited mobility to use the platform. For instance, in some examples, platform 230 includes four clamps, one for each of four wheels of a wheelchair. In some examples, each clamp is a mechanical clamp that includes two sides, so that for each wheel of the wheelchair, the wheel fits between the two sides of the clamp. In some examples, the two sides of each clamp compress upon the corresponding wheel and tire of the wheelchair, thus holding each of the four wheels of the wheelchair in place. In some examples, the two sides of each of the clamps are composed of rubber or another suitable material.

As further shown in FIG. 2, some examples of scissor lift 200 have lights 280 coupled to the bottom of platform 230 and/or mounting base 220. For instance, in some examples, light 280 include four CAZ lights on scissor lift 200, including one light that is coupled to mounting base 220 on the side that is opposite in direction to the side in which platform 230 is capable of horizontally sliding, and one light on each of the three sides of the platform other than the side that is opposite in direction to the side in which platform 230 is capable of horizontally sliding. Lights 280 may be laser lights, LED lights, or other suitable lights. In some examples, lights 280 demarcate a visual CAZ zone around lift 200. In some examples, each of the four lights 280 forms a line on the ground, such that the four lines form a visible rectangle around lift 200. In some examples, each of the lights forms only a line on the ground, with no other visible lights. In some examples, as shown in FIG. 2, each of the four lights in lights 280 form a separate visible two-dimensional plane. In some examples, each of these visible two-dimensional planes is a trapezoid. In some examples, each trapezoid includes a top base that is the edge of the platform 130 or mounting base 120 from which the light originates and a bottom base that is the line formed along the ground. For clarity, FIG. 2 shows only the horizonal edges of the CAZ lighting generated by lights 280 for the example illustrated.

In some examples, lights 280 form a visible CAZ zone around scissor lift 200 for which only personnel equipped with fall arrest equipment, fall restraint equipment, and/or other suitable personal protective equipment are permitted to enter. Personnel without such equipment may risk falling objects dropping on them, as well as other hazards. Accordingly, in some examples, the CAZ lights define a zone that should be avoided for safety reasons while scissor lift 200 is being operated. In some examples, instead of being pointed straight down, each of the lights 280 is angled outward slightly. In various examples, whether the visible CAZ zone is lines along the floor only, two-dimensional planes, or other suitable lighting, the visible CAZ zone created by lights 280 provides a boundary that should not be crossed by personnel lacking suitable protective equipment.

In some examples, the dimensions of the visible CAZ zone formed by lights 280 are adjustable based on the height of platform 230 relative to chassis 210, based on the swiveling of rotating scissor linkage base 211, and based on the horizontal sliding of platform 230 relative to mounting base 220.

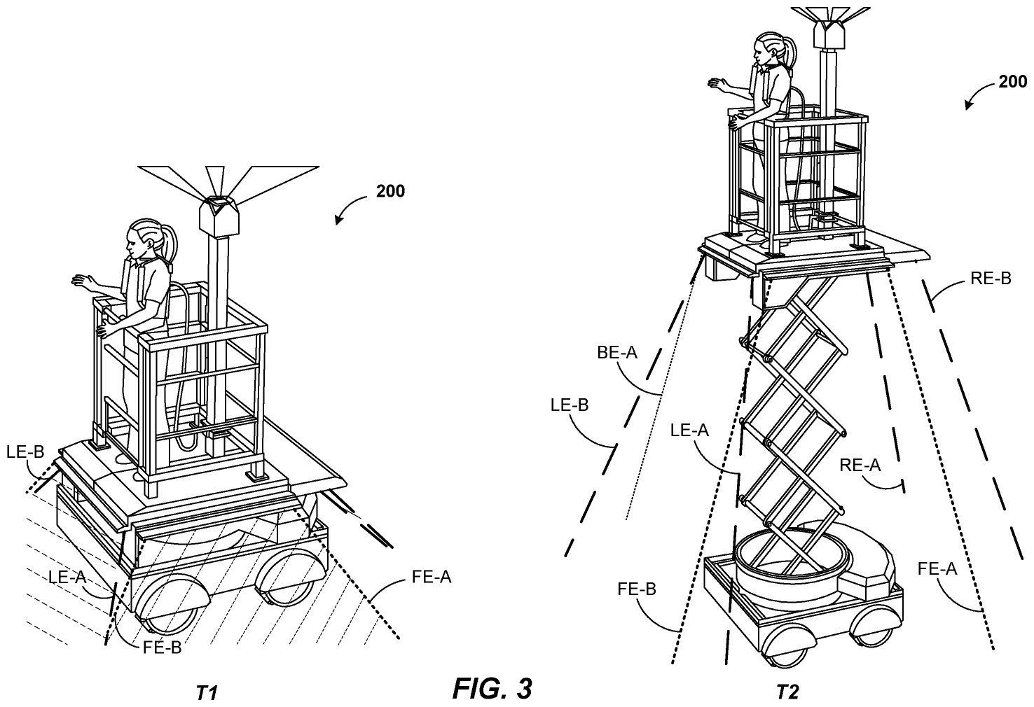

FIG. 3 is a diagram illustrating perspective views of an example a raising action of scissor lift 200 of FIG. 2 at times T1 and T2. More specifically, FIG. 3 illustrates an example of the raising of mounting base 220 relative to chassis 210. FIG. 3 illustrates an example of scissor lift 200 in a fully lowered position at time T1, and in a fully raised position at time T2. In some examples, scissor linkage 270 may raise mounting base 220 through pressure applied to the outside of the lowest set of supports on scissor linkage 270, which then elongates the crossing pattern on scissor linkage 270. In various examples, the contraction of the scissor action may be, for example, hydraulic, mechanical, pneumatic, and/or in another suitable manner.

In general, scissor lift 200 may include some means of providing power, along with some means, such as a motor, to provide motive power from that power, along with one or more other intermediary parts. Scissor lift 200 may use the same motor or other mechanism that provide all of the various movements such as raising scissor linkage 270 up and down, driving scissor lift 200 via wheels 201 or a track system or the like, the swiveling of the platform, the horizontal sliding of the platform, and/or other movement, or one or more of the movements may be provided based on one or more separate mechanisms.

For instance, in some examples, scissor lift 200 is powered by a bank of batteries that power a hydraulic pump. The hydraulic pump may be used to create hydraulic pressure that moves a hydraulic cylinder up and down in order to raise or lower scissor linkage 270. In some examples, a hydraulic motor is used to drive the wheels. An operator may control the various different mechanisms of scissor lift 200, such as driving, raising and lowering of the platform, swiveling of the platform, horizontal sliding of the platform, and/or the like in various different ways in various different examples. For instance, in some examples, a control panel, one or more foot panels, one or more other suitable user control interfaces, and/or the like may be used by the operator to control the various different operational functions of scissor lift 200.

In some examples, because lights 280 are angled outward slightly, the dimensions of the adjustable CAZ zone defined by lights 280 are greater the higher platform 230 is elevated relative to chassis 210. The precise increase in the dimensions of CAZ zone with increased height of platform 230 depends on angle of lights 280 relative to being pointed straight downwards. In some examples, the increase in the dimensions of the CAZ zone with increased height of platform 230 may be done because there may be a greater area of danger the higher platform 230 is elevated. For example, if an operator accidentally kicks a tool off of platform 230, the tool may go farther away from scissor lift 200 if platform 230 is higher.

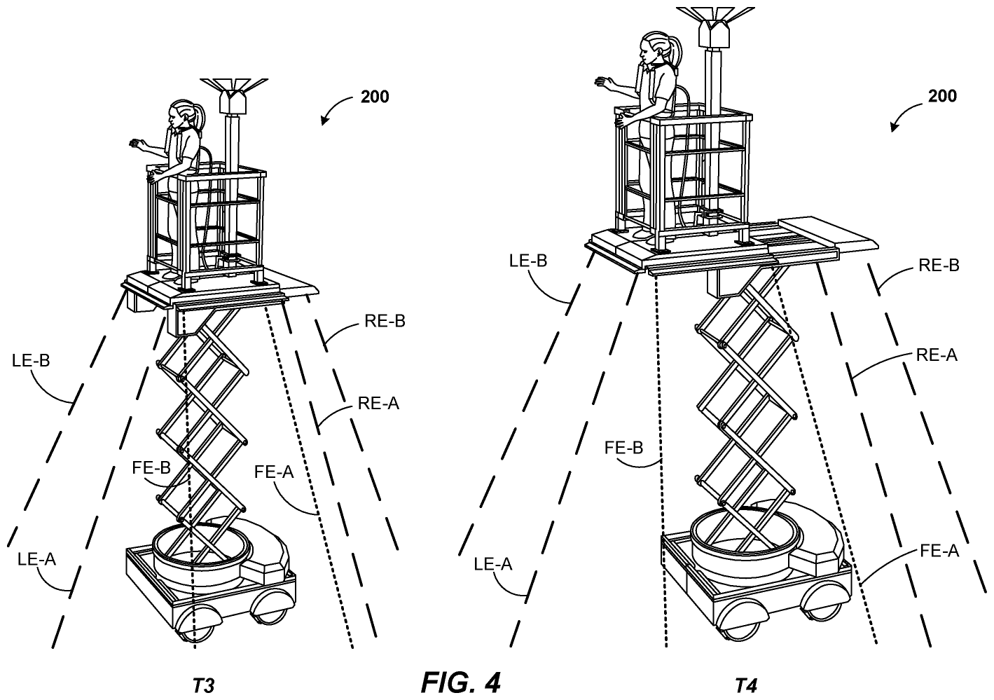

In FIG. 3, at time T1, the lights provided by lights 280 that are visible in the perspective shown in the illustrated example are indicated with shading. In FIG. 3, at time T2, for clarity, the horizontal edges of lights 280 only are shown for the example illustrated rather than showing each of the lighted areas as shaded. At time T2, FIG. 3 shows front light edges FE-A and FE-B of one of the lights 280, left light edges LE-A and LE-B of one of the lights 280, right light edges RE-A and RE-B of one of the lights 280, and back light edge BE-A of one of the lights 280. For clarity, only one back-light edge BE-A is shown at T2 of FIG. 3 because the other corresponding horizontal edge is partially obscured by scissor linkage 270. The light edges visible for time T1 are also shown for time T1 in FIG. 3 for the example illustrated. For the examples illustrated, FIG. 4 and FIG. 5 show light edges in a similar manner as discussed above with regard to time T2 of FIG. 3.

FIG. 4 is a diagram illustrating perspective views of an example of a horizontally sliding action of scissor lift 200 of FIG. 2. More specifically, FIG. 4 illustrates an example of the horizontal sliding of platform 230 relative to mounting base 220. FIG. 4 illustrates an example of scissor lift 200 in an initial raised position at time T3 (similar to that of FIG. 3 at time T2), and illustrates an example of scissor lift 200 at time T4 with platform 230, including the entire basket defined by platform 230 and guardrails 250, extended relative to the position at time T5. In some examples, as discussed above, platform 230 includes wheels that sit within grooved tracks at the toping of mounting base 220. In some examples, mounting base 220 includes motors that cause platform 230 to perform the horizontal sliding.

The weight and position of counterweight 260 may prevent scissor lift 200 from tipping over while the basket is extended. For instance, in some examples, counterweight 260 is positioned on scissor lift 200 on the side opposite of the direction in which platform 230 extends. Because in these example counterweight 260 is positioned on the side opposite of the direction in which platform 230 extends, the weight of counterweight 260 helps to prevent lift 200 from toppling over 200. In some examples, counterweight 260 is positioned on the side opposite of the direction in which platform 230 extends and has sufficient weight to keep lift 200 upright (i.e., prevent lift 200 from toppling over) while platform 230 is both fully extended and fully raised.

As illustrated in FIG. 4, the dimensions the adjustable CAZ zone defined by lights 280 changes based on the horizontal sliding of platform 230 relative to mounting base 220. More specifically, as discussed above, in some examples, three of the four lights 280 are on platform 230 and one of the four lights 280 is on mounting base 220. Accordingly, in some examples, when platform 230 extends relative to mounting base 220, the light 280 that is on mounting base 220 remains in place, and each of the three lights on platform 230 is displaced by an equal amount by which platform 230 is displaced. Accordingly, in some examples, the CAZ area defined by lights 280 is increased to encompass the additional unsafe area resulting from the extension of platform 230.

FIG. 5 is a diagram illustrating perspective views of an example of the swiveling of mounting base 220 relative to chassis 210. FIG. 5 illustrates an example of scissor lift 200 with platform 230 in a raised and extended position at time T5 (similar to that of FIG. 4 at time T4), and illustrates an example of scissor lift 200 at time T6 with mounting base 220 rotated about 90 degrees relative to chassis 210 compared to time T5. The swiveling action may be accomplished by rotation of rotating scissor linkage base 211. In some examples, rotating scissor linkage base 211 is accomplished by means of a slew gear. In some examples, the slew gear includes a rack-and-pinion-type gear on an excavator with a bearing incorporated into the gear. FIG. 5 also shows floor 205 at time T6.

In some examples, counterweight 260 is attached to rotating scissor linkage base 211 so that, when rotating scissor linkage base 211 rotates, counterweight 260 rotates in the same manner as rotating scissor linkage base 211. In some examples, because counterweight rotates in the same manner as rotating scissor linkage base 211, counterweight 260 remains on the side of scissor lift 200 that is opposite in direction to the direction in which platform 230 horizontally extends regardless of how platform 230 is rotated relative to chassis 210. In this way, the weight provided by counterweight 260 may prevent scissor lift 200 from tipping over regardless of how platform 230 is rotated relative to chassis 210.

As illustrated in FIG. 5, in some examples, the dimensions of the adjustable CAZ zone defined by lights 280 change based on the rotation of platform 230 relative to chassis 210.

The combination of the swiveling motion and the horizontal sliding of the platform may make it significantly easier and safer for the operator to perform certain functions. In some examples, the swiveling motion and the horizontal sliding are separate actions, but the platform can swivel while raised, or be raised while at any angle of rotation relative to the chassis. In some examples, the swiveling motion and the horizontal sliding functions both can be used to bring an operator closer to an item of interest. In some examples, the basket can be swiveled in a desired direction, and then the basket can be extended in a desired direction, which need not be the same direction as the direction of driving. For instance, typically, when an operator is using a scissor lift to perform work in a data center with server racks, the operator proceeds as follows. Typically, when the operator is working above a rack, the operator needs to do the work and then back up the scissor lift. Next, typically, the operator will then turn the scissor lift 90 degrees and then drive the scissor lift up to the next rack. Next, typically, the operator will then turn the scissor lift 90 degrees towards the rack, and then drive the scissor lift up to the next rack. However, according to some examples, scissor 200 lift may instead be used to swivel the basket 90 degrees and then extend the basket towards the rack. In these examples, the operator may then simply drive scissor lift 200 down the rack to perform work in each new area, with no backing up or turning needed.

As further shown in FIG. 2, scissor lift 200 may further include a mast 251 coupled to platform 230. In the example of scissor lift 200 illustrated in FIG. 2, proximity sensors 253 are coupled to mast 251. In some examples, mast 251 serves to elevate proximity sensors 253 so that portions of the operator's body, such as the operator's arms, do not interfere with proximity sensors 253. However, in some examples, there are proximity sensors 253 in location other than mast 251 in addition to or instead of proximity sensors 253 coupled to mast 251. Proximity sensors 253 may be used to help prevent scissor lift 200 and/or an operator inside of scissor lift 200 from colliding with anything outside of the basket and preventing the operator from being pinned between scissor lift 200 and anything outside of scissor lift 200.

In some examples, proximity sensors 253 may include one or more top sensors, where top sensors are proximity sensors that provide proximity sensing above scissor lift 200 in order to prevent the operator from being pinned between scissor lift 200 and anything above the lift, and to prevent scissor lift 200 or the operator from colliding with anything above scissor lift 200, or such as the ceiling, structural beams, and/or other obstructions or potential hazards, and to prevent the operator's head from being crushed by an overhead physical obstruction or hazard. The top sensors of proximity sensors 253 may be positioned in different suitable locations in different examples. In some examples, the top sensors of proximity sensors 253 are positioned at the top of mast 251 or otherwise positioned to sense obstructions above scissor lift 200.

In some examples, in addition to or instead of proximity sensors 253 that are top sensors that provide proximity sensing above scissor lift 200, proximity sensors 253 may include one or more side sensors, where the side sensors are proximity sensors that provide proximity sensing at the sides of scissor lift 200. For instance, in some examples, proximity sensors 253 that are side sensors may prevent the operator from being pinned between scissor lift 200 and surrounding objects, and to prevent collisions or encounters with various hazards or conditions, such as colliding with people or property, holes in the ground, other unstable ground conditions, and/or the like. The side sensors of proximity sensors 253 may be positioned in different suitable locations in different examples. In some examples, the side sensors of proximity sensors 253 are positioned somewhere on the sides of scissor lift 200 such as on the sides of one or more of the following: guardrails 250, platform 230, mounting base 220, chassis 210, or another suitable location.

In some examples, proximity sensors 253 may first provide some type of auditory and/or visual warning when a nearby hazard is detected, such as by sounding an alarm. In some examples, in addition to provide an auditory and/or visual warning when a nearby hazard is detected, if proximity sensors 253 detect that a hazard is particularly close, proximity sensors 253 may cause the operation of scissor lift 200 to cease in order to prevent a collision with a hazard or the like.

In addition to proximity sensors 253, scissor lift 200 may also include one or more other types of sensors for various safety reasons. For instance, in some examples, scissor lift 200 includes a tilt sensor that sounds an alarm if scissor lift 200 is in danger of topping over. In some examples, operation of scissor lift 200 is ceased if the tilt sensor indicates that scissor lift 200 is in danger of toppling over. Various suitable types of tilt sensors may be employed in various examples. In some examples, the tilt sensor may include a ball-in-cage switch. The ball-in-cage switch may include a metal ball that is enclosed within a cage that also includes a circuit. In some examples, if the ball-in-cage switch is tilted sufficiently, the ball moves out of position due to the tilting and breaks the circuit. In some examples, the tilt is detected by detecting the breaking of the circuit.

In some examples, platform 230 is pressure sensitive. In these examples, scissor lift 200 is able to detect whether the full weight of the operator is on platform 230. If the full weight of the operator is not on platform 230, this may indicate a dangerous situation, such as the operator attempting to climb over or onto guardrails 250. In some examples, if such a condition is detected by the pressure detection on platform 230, operation of scissor lift 200 is shut down. The precise weight detected may be different in different examples. For instance, in some examples, the weight detected is not based on the actual weight of the particular operator, but rather, the weight that the pressure detection senses is a weight that is relatively near zero, but significantly greater than the expected weight of an expected set of tools. Accordingly, in these examples, if the pressure detection senses weight greater than the target weight (e.g., near zero but significantly greater than an expected set of tools), then the pressure-sensitive platform senses that the weight of the operator is still on platform 230. In these examples, if instead the pressure detection senses weight less than the target weight, then the pressure-sensitive platform senses that the weight of the operator is no longer on platform 230. In some examples, instead of detecting a weight near zero, the target weight may be calibrated at initial lift using the weight on platform 230 and an average or plausible weight of a human.

In some examples, scissor lift 200 may also use artificial intelligence (AI)-based cameras to detect whether an operator has fallen off or otherwise left platform 230 during the operation of scissor lift 200. The AI may be programmed to detect human shapes, and use the cameras to determine whether an operator is no longer on platform 230. In some examples, scissor lift 200 may cease operation if it is determined that the operator is no longer on platform 230.

In some examples, scissor lift 200 may use badge detection. The badge detection may require that a proper badge be properly presented to the badge detection system in order to operate scissor lift 200. In some examples, personnel are not assigned a badge to operate scissor lift 200 without the proper training and qualifications needed to operate a scissor lift.

In some examples, in addition to the swiveling of platform base, the entire scissor lift 200 may spin/rotate in place, by means of wheel 201 or a track system coupled to the bottom of chassis 210 that drives scissor lift 200. For instance, in some examples, scissor lift 200 has a track system instead of wheels 202, and the track system enables scissor lift 200 to rotate in place. In some examples, the track system is similar to the track system of a tank, and allows scissor lift 200 to rotate in place in a similar manner in which a tank with a track system rotates in place.

In some examples, wheels 201 are mecanum wheels that enable scissor lift 200 rotate in place. In these examples, the mecanum wheels may allow scissor lift to move in any direction and to rotate in place. In some examples, wheels 201 are not mecanum wheels, but wheels 211 allow scissor lift 200 rotate in place by means of separate hydraulic motor coupled to each of the wheels enabling scissor lift 200 to spin in place. The wheels 211 or treads may cause chassis 210 to spin/rotate in place, thereby causing the entire scissor like 200 to spin/rotate in place.

Although a scissor lift is illustrated in FIGS. 2-5, other suitable lifts may be used in various examples. For instance, in some examples, a hydraulic lift may be used rather than a scissor lift.

### Illustrative Process

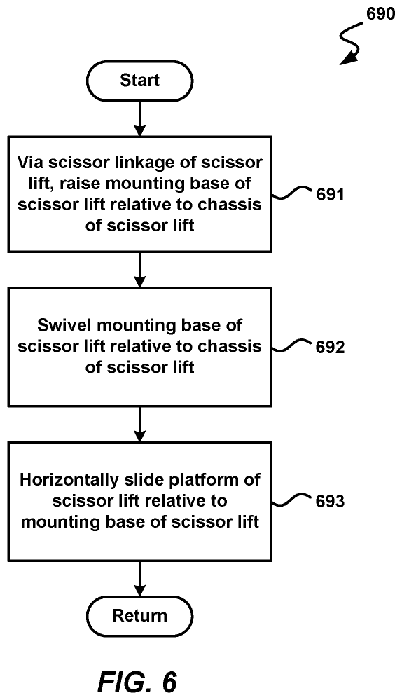

FIG. 6 is a diagram illustrating an example dataflow for a process (690) for a lift. In some examples, process 690 may be performed by an example of lift 100 of FIG. 1, scissor lift of FIG. 2, and/or the like.

In the illustrated example, step 691 occurs first. At step 691, in some examples, via a scissor linkage of a scissor lift, a mounting base of the scissor lift is raised relative to a chassis of the scissor lift. As shown, step 692 occurs next in some examples. At step 692, in some examples, the mounting base of the scissor lift is swiveled relative to the chassis of the scissor lift. As shown, step 693 occurs next in some examples. At step 693, in some examples, a platform of the scissor lift that is coupled to the mounting base of the scissor lift is slid horizontally relative to the mounting base of the scissor lift. The process may then advance to a return block, where other processing is resumed.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. A lift, comprising:
a chassis;
a mounting base that is arranged to swivel relative to the chassis;
a platform that is movably affixed to the mounting base, wherein the platform is arranged to slide horizontally relative to the mounting base;
a motor that is arranged to raise and lower the mounting base relative to the chassis;
a plurality of guardrails coupled to the platform; and
a counterweight that is coupled to the chassis such that the lift remains upright while the platform is extended relative to the mounting base.

2. The lift of claim 1, further comprising a track system coupled to a bottom of the chassis, wherein the track system is capable of causing the chassis to rotate in place.

3. The lift of claim 1, further comprising a scissor linkage that is coupled to the chassis and is coupled to the mounting base, wherein the motor is arranged to cause the mounting base to raise relative to the chassis by elongation of the scissor linkage.

4. The lift of claim 1, wherein the platform is a pressure-sensitive platform, and wherein the lift is arranged to cease operation of the lift responsive to the pressure-sensitive platform detecting that weight of an operator is no longer on the pressure-sensitive platform.

5. The lift of claim 1, further comprising a plurality of clamps that are coupled to the platform, wherein the clamps of the plurality of clamps are arranged to lock a wheelchair in place onto the platform.

6. The lift of claim 1, further comprising a tilt sensor that is arranged to detect whether the lift is at risk of toppling over.

7. The lift of claim 1, further comprising a badge access system, wherein the badge access system does not now allow the lift to be operated unless the badge access system is accessed with a proper badge.

8. The lift of claim 1, further comprising a rotating base that is coupled to the top of the chassis, wherein the rotating base is arranged to enable the mounting base to swivel relative to the chassis.

9. The lift of claim 1, wherein the counterweight is further configured to extend outwards based on the platform extending relative to the mounting base.

10. The lift of claim 1, the lift further comprising a plurality of proximity sensors, wherein the plurality of proximity sensors is arranged to detect at least one of physical obstructions above the lift or physical obstructions around the lift.

11. The lift of claim 10, wherein the plurality of proximity sensors is arranged to provide at least one of an auditory warning or a visual warning if a physical obstruction is detected.

12. The lift of claim 1, further comprising a plurality of lights, wherein the plurality of lights is arranged provide a visible controlled access zone around the lift, and wherein each light of the plurality of lights is coupled to at least one of the platform or the mounting base such that the plurality of lights raise and lower along with the raising and lowering of the mounting base.

13. The lift of claim 12, wherein each light of the plurality of lights is at least one of a laser light or a light-emitting-diode (LED) light.

14. The lift of claim 12, wherein the plurality of lights is arranged such that dimensions of the visible controlled access zone change based on at least one of the raising and lowering of the mounting base, the platform sliding horizontally, or the mounting base swiveling.

15. The lift of claim 12, wherein the plurality of lights is arranged such that the visible controlled access zone increases in size when the mounting base is raised relative to the chassis.

16. The lift of claim 12, wherein the plurality of lights is arranged such that dimensions of the visible controlled access zone change based on the platform sliding horizontally.

17. The lift of claim 12, wherein the plurality of lights is arranged such that dimensions of the visible controlled access zone change based on the mounting base swiveling.

18. A scissor lift, comprising:
a chassis;
a rotating scissor linkage base that coupled to a top of the chassis and that is arranged to swivel relative to the chassis;
a mounting base;
a scissor linkage that is coupled to the rotating scissor linkage base and is coupled to the mounting base;
a platform that is movably affixed to the mounting base, wherein the platform is arranged to slide horizontally relative to the mounting base;
a motor that is arranged to cause the scissor linkage to move to raise and lower the mounting base relative to the chassis; and
a counterweight that is coupled to the chassis such that the counterweight prevents the lift from tipping over while the platform is extended relative to the mounting base.

19. A method, comprising:
via a scissor linkage of a scissor lift, raising a mounting base of the scissor lift relative to a chassis of the scissor lift;
swiveling the mounting base of the scissor lift relative to the chassis of the scissor lift; and
sliding a platform of the scissor lift that is movably affixed to the mounting base of the scissor lift horizontally relative to the mounting base of the scissor lift.

20. The method of claim 19, further comprising:
via a plurality of wheels of the scissor lift that are coupled to a bottom of the chassis of the scissor lift, causing the scissor lift to rotate in place.
